(19) United States
(12) Patent Application Publication
(10) Pub. No.: US 2007/0244840 A1
(43) Pub. Date: Oct. 18, 2007

(54) System and Method for Enabling Seekers to Create and Post Challengers for Solvers

(76) Inventor: Darren J. Carroll, Nobesville, IN (US)

Correspondence Address: MINTZ LEVIN COHN FERRIS GLOVSKY & POPEO, 666 THIRD AVENUE, NEW YORK, NY, 10017, US

(21) Appl. No.: 10/573,298

(22) PCT Filed: Sep. 13, 2004
(86) PCT No.: PCT/US04/26735

§ 371 Date: Feb. 12, 2007

Related U.S. Application Data
(60) Provisional application No. 60/504,206, filed on Sep. 22, 2003.

(51) Int. Cl. G06Q 99/00; G06F 17/00

(52) U.S. Cl. 705/500

(57) ABSTRACT

The invention relates to an improved system and method for enabling Seekers to create and post challenges for Solvers in a networked system.

### FIELD OF THE INVENTION

The invention relates to an improved system and method for enabling Seekers to create and post challenges for Solvers in a networked system.

### BACKGROUND OF THE INVENTION

A networked system for creating a community of people to solve problems in general is known. One example of such system is operated by InnoCentive, Inc. (“InnoCentive”), at Andover, Mass. InnoCentive's system has created a web-based community from around the globe. It provides an online forum enabling major companies to reward scientific innovation through financial or other incentives. In general the system matches “Seekers” and “Solvers.” A scientist (or other individual or entity) can register as a “Solver” to gain access to opportunities to find challenges that match their skills and interest and receive professional recognition and significant financial rewards for finding solutions to the challenges. Companies (or other entities or individuals) seeking R&D (or other) solutions can post challenges for which they are seeking a solution, and become a “Seeker” to gain immediate access to a pool of leading scientific or other talent.

As part of the operation of the system, Seekers post R&D (or other) challenges to a website (or otherwise disseminate the challenge to notify some or all of the potential Solvers). Each challenge includes sufficient information to describe the challenge, the reward, the criteria and/or other challenge related information. Certain aspects of this information may be kept confidential. Some information may be available to all Solvers, and some information may be available to only Solvers meeting certain criteria. In some cases only a summary of the information is initially provided to the Solvers. Other alternatives exist.

In any event, an important part of the system is for Seekers to post (or otherwise disseminate) information about Challenges to the website (or otherwise). The existing system enables the posting of information about challenges, but the process can be improved.

### SUMMARY OF THE INVENTION

The invention relates to an improved system and method for enabling Seekers to create and post challenges for Solvers in a networked system.

One aspect of the invention relates to a system and method to facilitate the creation and posting of challenges. According to one embodiment, the invention comprises a template driven interface that facilitates the ability for Seekers to create and post challenges for Solvers. By way of example, the interface may include one or more screens that guide a user through the process of creating a challenge. A user, as referred to in this context, is intended broadly to include someone who is accessing the system to create a challenge on behalf of a Seeker.

According to one embodiment of the invention, one of the templates may include a display that enables a user to select from options that will enable the user to create a new challenge or work with an existing one (for example one that has been stored). Existing challenges may be opened and modified or used as templates for new challenges.

One of the steps may involve providing user and/or Seeker identification and/or contact information. Another step may involve providing background information relating to the challenge. For example, this may include one or more types of information such as scientific background information, the Seeker's (or other company's) history relating to the challenge and/or other background information. Another step may involve providing detailed information regarding the challenge. This can include providing one or more of a detailed description, supporting information, solution criteria, award information and/or other detailed information. An option to attach relevant information (images, documents audio files, video files or other attachments) may be provided to facilitate the ability to attach existing documents or other files created using a separate application that are stored on a hard drive, network drive or otherwise stored but accessible to the user. Another step may involve providing an Abstract or summary of the challenge. If desired the user can specify at an appropriate point in the process whether a reduction to practice is required or not and other relevant parameters.

Another step in the process may include providing information regarding resource requirements relating to the challenge. For example, the user may specify resources such as human resources, equipments, laboratory, computer processing, storage capacity, or other resources likely to be required to address the challenge.

Another step in the process may include providing information relating to potential Solvers. For example, this step may include identifying disciplines to which the challenge relates, specific categories within the disciplines, and/or other target solver information

Another step may include providing information regarding available potential resources that may be useful in helping to solve the challenge. Such resources may include, for example, known experts, relevant science conferences, industry organizations, journals (or other publications), relevant patents and other potential resources that may be available to assist the Solver in addressing the challenge.

Each or some of the foregoing steps may be facilitated by presenting to the user one or more templates (e.g., via a graphical user interface), which enable the user to click on options, use drop down or check boxes (and other GUI tools) to select text or other items, text boxes to enter text and/or other options. Each of the templates may include context sensitive help boxes that can be readily accessed by the user. Examples or sample entries may be provided in conjunction with the help boxes or may be separately provided.

After all of the desired information is specified, the system can present a summary of the information (entered for example in different screens) for review by the user all in one screen. Any attachments can be presented for review as well. From this screen the user can approve or modify any of the previously entered information and save the information.

According to one embodiment, the information can be saved as a Word document (or in other desired format). For example, the system can provide the user an option to specify the format in which the document should be saved, where the document should be saved and a file name for the document According to another aspect of the invention, saved challenges previously prepared by the user can be saved and recalled for subsequent modification and/or for use as a template for new challenges. Once a challenge has been saved it can be posted to the network in accordance with the procedures established by the system operator.

Other objects and features of the invention will become apparent from the following detailed description considered in connection with the accompanying drawings that disclose embodiments of the invention. It should be understood, however, that the drawings are designed for purposes of illustration only and not as a definition of the limits of the invention.

### BRIEF SUMMARY OF THE INVENTION

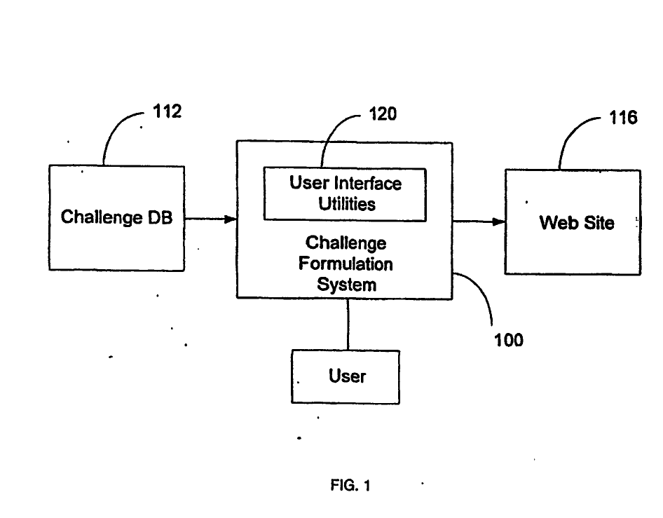

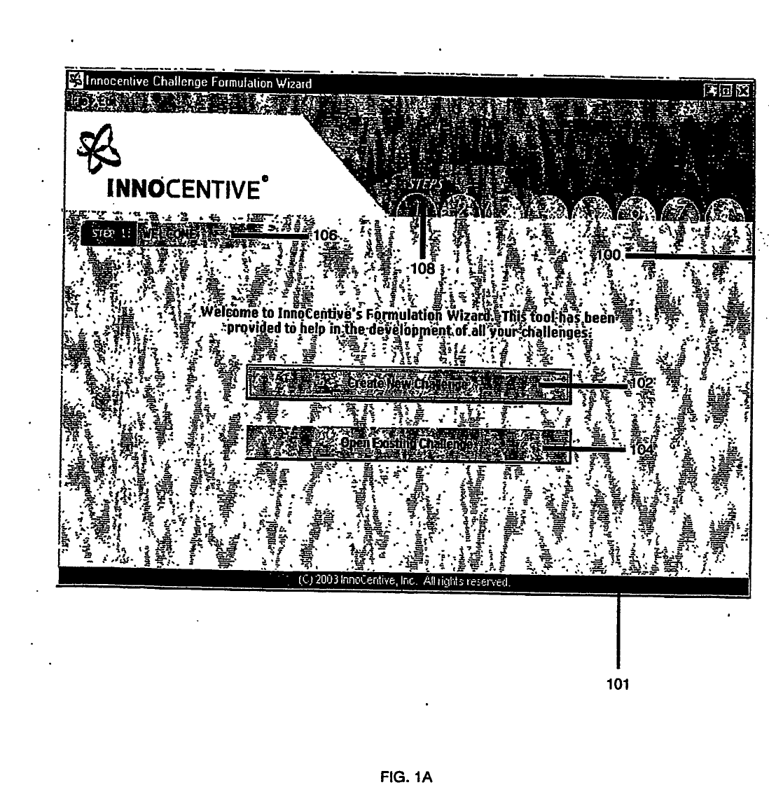

FIG. 1 illustrates an example of a system architecture for a challenge formulation, according to an embodiment of the invention.

FIG. 1A illustrates an example of a user interface of a challenge formulation system, according to an embodiment of the invention.

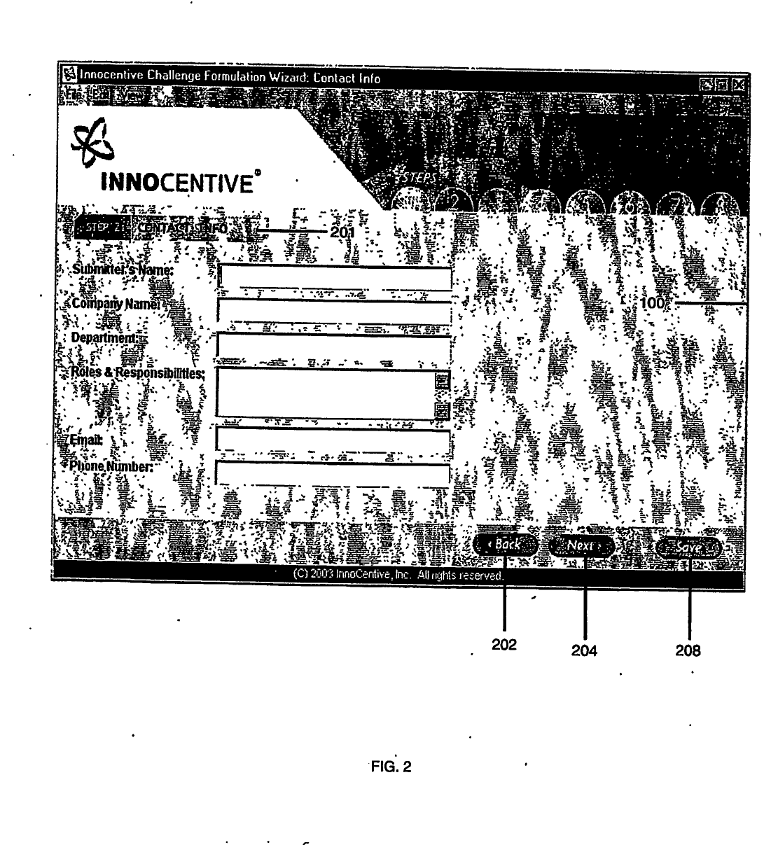

FIG. 2 illustrates an example of a contact information input utility of a challenge formulation system, according to an embodiment of the invention.

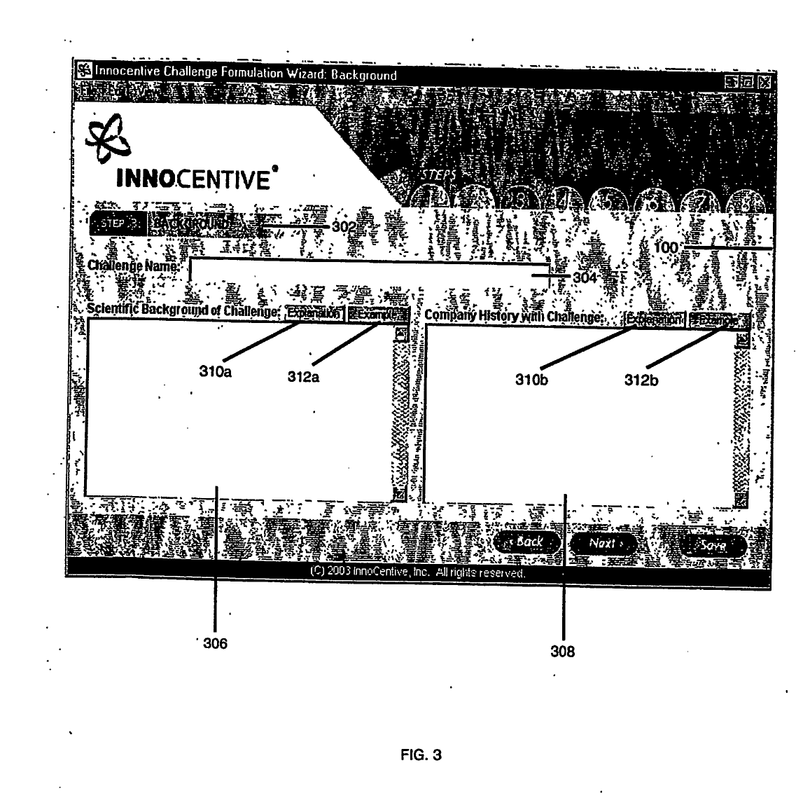

FIG. 3 illustrates an example of a background information input utility of a challenge formulation system, according to an embodiment of the invention.

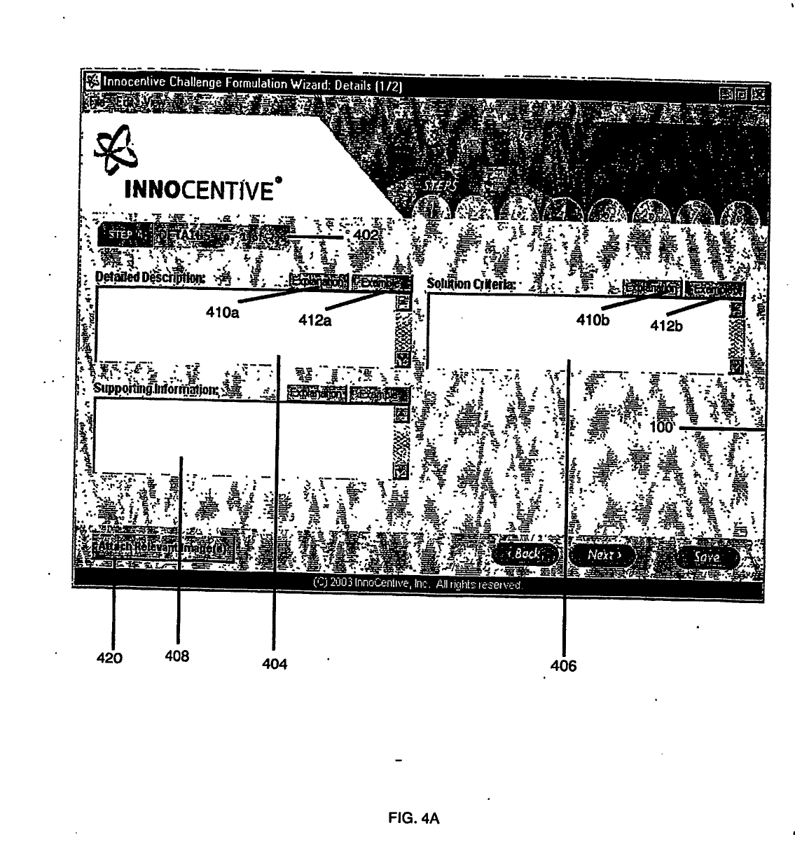

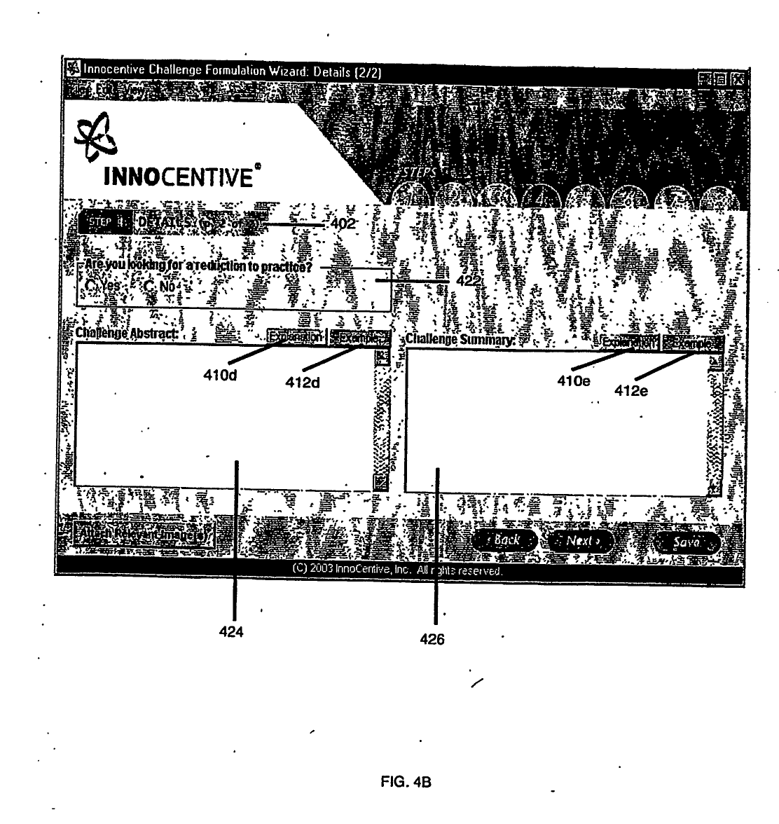

FIG. 4A illustrates an example of a detail information input utility of a challenge formulation system, according to an embodiment of the invention.

FIG. 4B illustrates an example of a detail information input utility of a challenge formulation system, according to an embodiment of the invention.

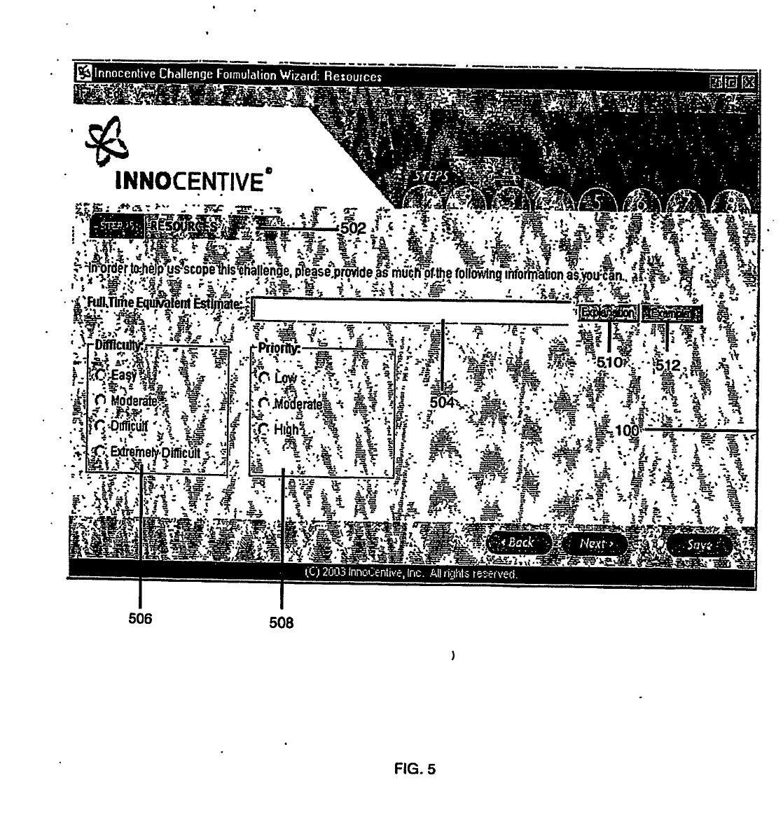

FIG. 5 illustrates an example of a resource information input utility of a challenge formulation system, according to an embodiment of the invention.

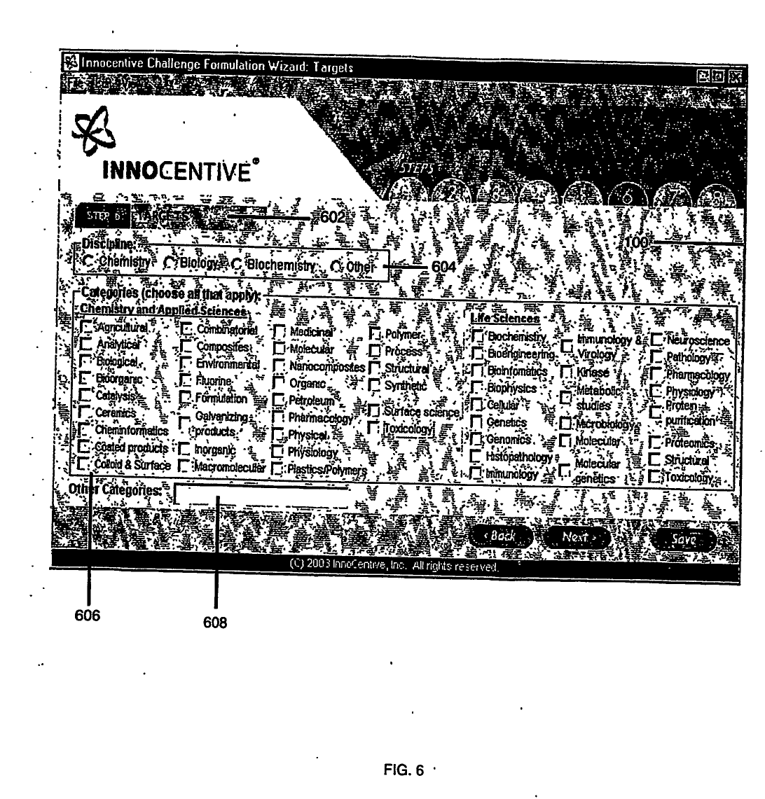

FIG. 6 illustrates an example of a target area specification utility of a challenge formulation system, according to an embodiment of the invention.

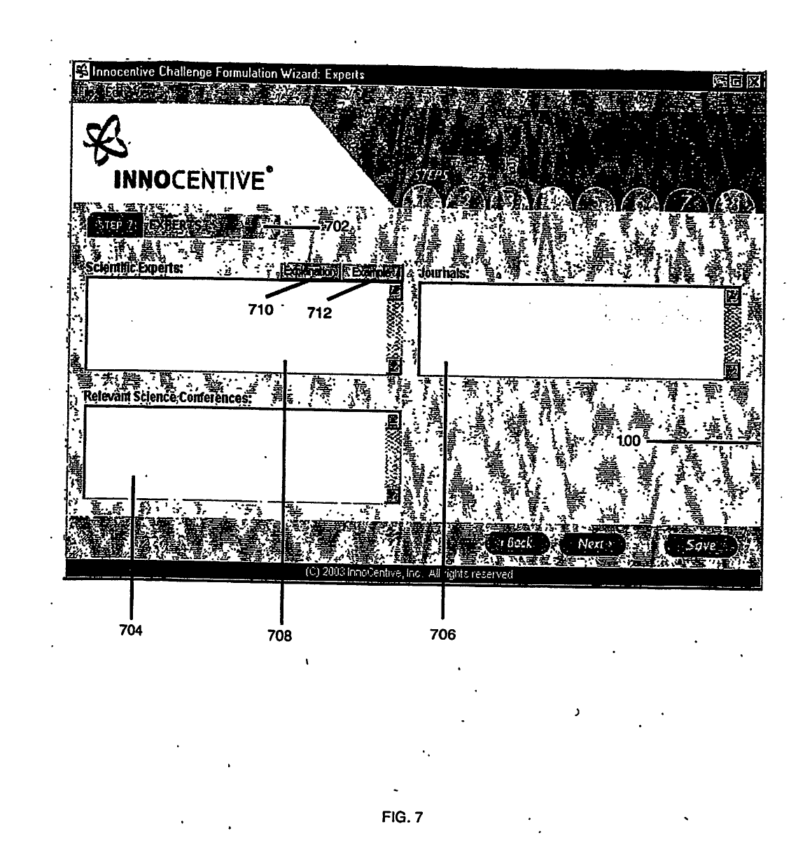

FIG. 7 illustrates an example of a reference specification utility of a challenge formulation system, according to an embodiment of the invention.

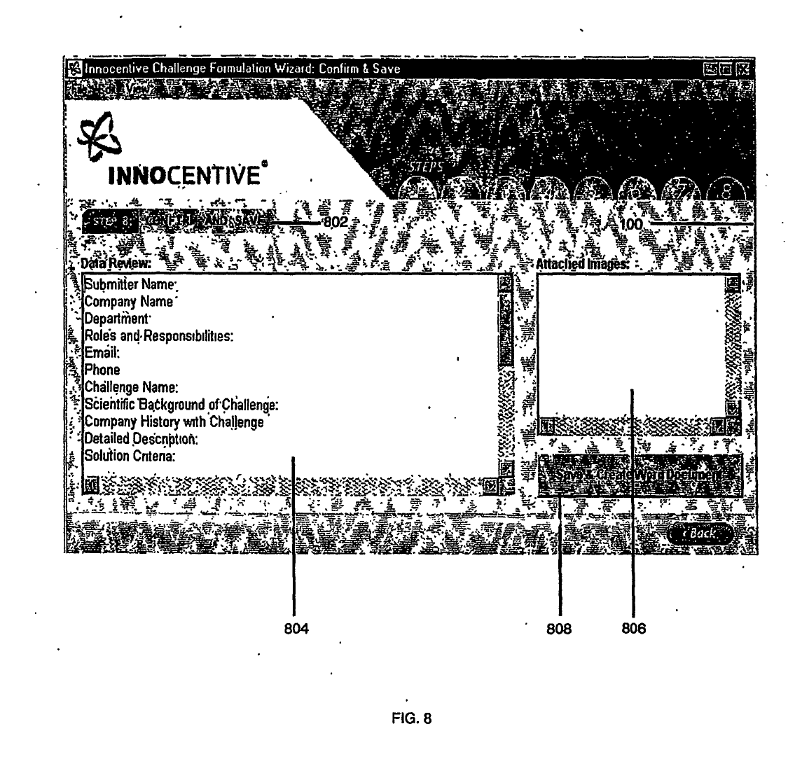

FIG. 8 illustrates an example of a confirmation utility of a challenge formulation system, according to an embodiment of the invention.

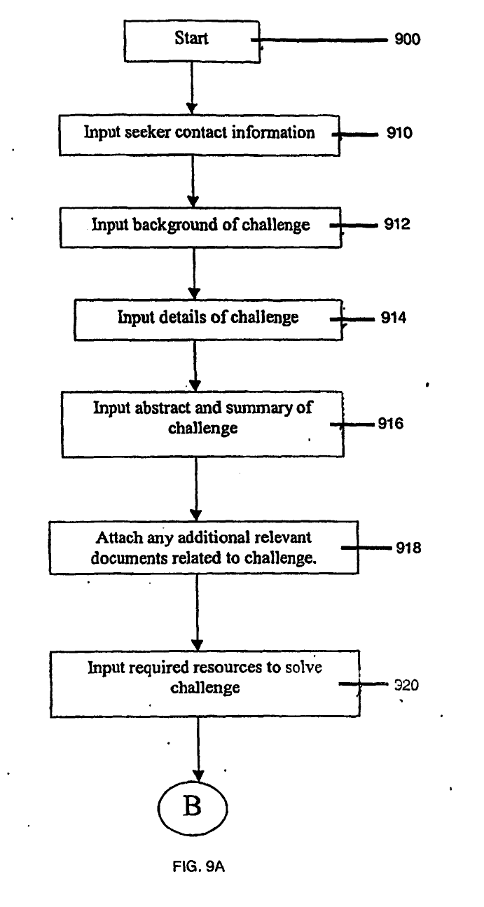

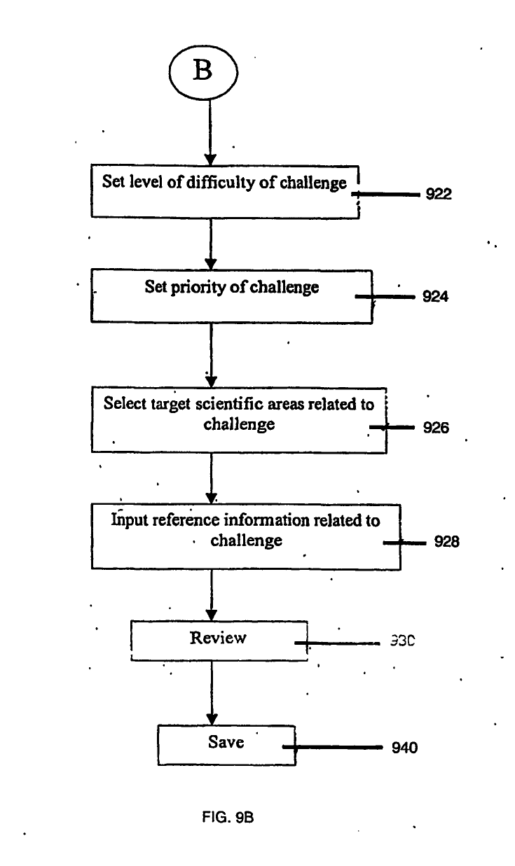

FIG. 9A illustrates an example of a process of creating a challenge for solvers, according to an embodiment of the invention.

FIG. 9B illustrates an example of a process of creating a challenge for solvers, according to an embodiment of the invention.

### DETAILED DESCRIPTION OF THE INVENTION

One aspect of the invention relates to a challenge formulation system and method to facilitate the creation and posting of challenges. As illustrated in FIG. 1, a challenge formulation system 100 may be coupled to one or more databases, for example, a challenge database 112 and a website 116 in a network. Challenge database 112 may be used for storing any new challenge or one or more of previously created challenges. Website 116 may be used for posting any new challenge or one or more of previously created challenges.

According to one embodiment, challenge formulation system 100 may include one or more template driven interface utilities 120 that may facilitate the ability for users (e.g., seekers) to create and post challenges for solvers. A user of challenge formulation system 100 may be an individual or an entity who is authorized to create, modify or post a challenge. In one embodiment, a user is a seeker who seeks to solve a challenge. In an alternative embodiment, a user is a middle-man or an entity other than a seeker and a solver. As illustrated in FIGS. 1A and 2-8, one or more template driven interface utilities 120 may include, for example, a challenge selection utility 101, a contact input utility 201, a background input utility 302, a detail information input utility 402, a resource input utility 502, a target area specification utility 602, a reference specification utility 702, and a confirmation utility 802.

According to the invention, challenge selection utility 101 may be used to enable a user to specify whether to create a new challenge or work with an existing challenge. According to one embodiment, challenge selection utility 101 may include one or more user selection objects, for example, a new challenge selection object 102 and an existing challenge selection object 104. A user or a Seeker may select new challenge selection object 102 for creating a new challenge and existing challenge selection object 104 for opening an existing challenge that was previously created and stored. An existing challenge may be opened or modified or may be used to create a new challenge using the existing challenge or portions thereof as a template.

In some embodiments, challenge selection utility 101 may include a message input tool 106. Message input tool 106 may enable a user to input a message, for example, a welcome message for Solvers.

According to another embodiment, as illustrated in FIG. 2, contact info input utility 201 may include one or more features that enable a user to input the user's profile information, for example, but not limited to user's name, company name, department, roles and responsibilities, e-mall, phone, web-page or other contact related information.

During challenge creation, a user may need to provide sufficient as well as required information about a challenge so that a Solver call easily understand the challenge and work on the challenge. According to another embodiment, background input utility 302 may enable a user to input background information on a challenge. Background input utility 302 may include one or more input tools, for example, but not limited to a challenge name input tool 304, a scientific background input tool 308, a history input tool 308, etc. Furthermore, background input utility 302 may also include help features, for example, explanation help tool 310, example help tool 312 that may help a user input background information.

Challenge name input tool 304 may enable a user or provide a name for a challenge. Scientific background input tool 306 may enable a user to input scientific background information of a challenge, for example, importance of the challenge, prior scientific work, etc. History input tool 308 may enable a user to input user's or user's company history with the challenge, for example approaches that had been tried by the user or the user's company to solve the challenge. A user may also input confidential information within scientific background information or history information of a challenge. Background input utility 302 may include features for a user to specify any confidential information and authorize accessibility to one or more of other users.

In some embodiments, if a user needs help for inputting background information, a user may select explanation help tool 310a and/or example help tool 312a. In response to user selecting explanation help tool 310a, challenge formulation system 100 may provide a pop-up window that may include help information, for example, what type of scientific background information needs to be inputted, etc. In response to user selecting example help tool 312a, challenge formulation system 100 may provide a pop-up window that may include example information such as an example of a scientific background of a challenge.

According to the invention, detail information input utility 402 may enable a user to input detailed information of a challenge. As illustrated in FIGS. 4A and 4B, detail information input utility 402 may include, for example, a detailed description tool 404, a supporting information tool 408, a solution criteria tool 406, an abstract input tool 424, and a summary input tool 426. Detailed description tool 404 may enable a user to input a detailed description of a challenge, for example, details of the challenge, details of the approaches that has been tried, etc. Supporting information tool 408 may enable a user to input supporting references, for example, relevant scientific literatures, web sites, or any additional information that could be provided to Solvers. Solution criteria tool 406 may enable a user to input a defined or specific solution criteria to solve a challenge. Solution criteria may include, for example, required methodology, materials to be avoided etc., to solve the challenge.

As illustrated in FIG. 4B, abstract input tool 424 may enable a user to input an abstract of a challenge. Abstract of a challenge may be in few sentences. Summary input tool 426 may enable a user to input a summarized information of a challenge.

In some embodiments, details input utility 402 may include help features, for example an explanation help tool (410a-e) and an example help tool (412a-e) that may help users in deciding type of information to be inputted into detailed description tool 404, supporting information tool 408, solution criteria tool 406, abstract input tool 424, and summary input tool 426.

In some embodiments, detail information input utility 402 may include a document attaching tool 420 to attach additional relevant information (images, documents, etc.). Document attaching tool 420 may facilitate the ability to attach existing documents or documents created using a separate application that are stored on a hard drive, network drive or otherwise stored but accessible to the user. In some embodiments, a user may select attaching tool 420 to browse through a folder for selecting and retrieving a document from a hard drive, network drive or otherwise stored but accessible to the user.

According to another embodiment, as illustrated in FIG. 4B, details input utility 402 may include a specification feature 422 that may enable a user to specify, for example, a reduction to practice of the challenge is required or not.

According to another embodiment, as illustrated in FIG. 5, resource input utility 502 may enable a user to input one or more resources required to solve a challenge. The required one or more resources may include, for example, human resources, equipments, laboratory, computer processing or storage capacity, etc. In an exemplary embodiment, resource input utility 502 may include an input box 504 that may enable a user to input number and level of full-time staff required to solve the challenge. Resource input utility 502 may also include help tools (e.g., 510, 512).

According to another aspect of the invention, challenge formulation system 100, as illustrated in FIG. 5, may include a difficulty level specification utility 506 and a priority specification utility 508. Difficulty level specification utility 506 may enable a user to specify a level of difficulty (e.g., easy, moderate, difficult, extremely difficult) to solve a challenge. Priority specification utility 508 may enable user to specify a level of priority (e.g., low, moderate, high) of a challenge.

According to another embodiment, as illustrated in FIG. 6, target area specification utility 602 may include, for example, a discipline specification tool 604, a category specification tool 606, and other category tool 608.

Discipline specification utility 604 may enable a user to specify one or more broad disciplines related to a challenge. Category specification tool 606 may enable a user to specify one or more sub-categories that fall within one or more broad disciplines. Other category tool 608 may enable a user to specify other categories that do not fall within one or more broad disciplines.

According to another embodiment, as illustrated in FIG. 7, reference specification utility 702 may include on or more tools (e.g., 704, 706, and 708) that may enable a user to specify reference information related to a challenge, for example, scientific experts, journals, and relevant conferences related to the challenge. Reference Specification utility 702 may also include help tools (e.g., 710, 712).

According to another embodiment, as illustrated in FIG. 8, confirmation utility 802 may enable a user for confirming and saving the inputted information and/or documents to solve a challenge. Confirmation utility 802 may include a data review tool 804 and a document review tool 806. A user may review the inputted information using a data review tool 804 and the attached documents using document review tool 806. Confirmation utility 802 may also include a save button 808. After reviewing the inputted data and documents, the user may save the created challenge by selecting save button 808.

According to another aspect of the invention, one or more template driven interface utilities 120 may also include various other features including a step indicator 108 and navigation tools as illustrated in FIGS. 1A and 2-8. Step indicator 108 may indicate, for example, total number of steps in the challenge creation or other step related information. In some embodiments, template driven interface utilities 120 may include a navigation tool for enabling a user to navigate various steps in the challenge creation. As illustrated in FIG. 2, template driven interface utilities 120 may include a back button 202 and a next button 204 that may enable a user go back and forth various steps in the challenge creation. After inputting an information in each step, a user may save the inputted information by selecting, for example, a save button 208.

FIGS. 9A and 9B illustrate a process of creating a challenge for Solvers, according to the invention. As shown in operation 910, a user/Seeker may input his/her contact information for Solvers. As shown in operation 912, a user may input background information for Solvers. As shown in operation 912, a user may input background information of a challenge. Background information may include, for example, scientific background of a challenge, user's history in solving the challenge, etc. As shown in operation 914, a user may input detail information of a challenge. Detail information may include, for example, detailed description of the challenge, supporting information (e.g., relevant literatures, website, etc.) for the challenge, solution criteria (e.g., defined or specific methodology to be used for solution, etc.) for solving the challenge, etc. As shown in operation 916, a user may input abstract and/or summary information of the challenge. As shown in operation 918, a user may attach any additional documents (e.g., web or non-web documents, image files, etc.) related to the challenge. Required resources may include for example, human resources, equipments, laboratory, computer processing or storage capacity, etc.

As shown in operation 922, a user may set a level of difficulty (e.g., easy, moderate, difficult, extremely difficult) to solve the challenge. As shown in operation 924, a user may set priority (e.g., low, moderate, high) to solve the challenge. As shown in operation 926, a user may review the inputted data. As shown in operation 940, a user may save the data and authorize one or more Solvers to access the inputted data.

While a particular embodiment of the present invention has been described, it is to be understood that modifications will be apparent to those skilled in the art without departing from the spirit of the invention.

What is claimed is:

1. A system for enabling Seekers to create and post challenges for Solvers in a networked system, the system comprising a template driven interface that:
enables a user to select whether to create a new challenge or work with an existing challenge that has previously been stored, and if the user selects to create a new challenge, presents to the user a series of templates that prompts the user for input relating to the challenge to be created, the prompts including one or more of: an identification prompt; a background information prompt; a detailed information prompt regarding the challenge; a resources required prompt; an abstract of the challenge; a potential target Solvers information prompt; and a potential available resources prompt;
receiving user input in response to the prompts;
generating a challenge in response to the user input and system rules; and
posting the challenge to a network accessible.

2. The system of claim 1 wherein after all of the desired information is specified, the system can present a summary of the all entered information for review by the user in one screen.

3. The system of claim 1 wherein after all of the desired information is specified, the system can present a summary of the information entered for review by the user and a list of any attachments specified by the user.

4. The system of claim 2 wherein from the summary review screen, the user can approve or modify any of the previously entered information and save the information in a specified format.

5. The system of claim 4 wherein the system can provide the user an option to specify the format in which the document should be saved, where the document should be saved and a file name for the document.

6. The system of claim 1 wherein challenges previously prepared by the user can be saved and recalled by the user for subsequent modification and/or for use as a template for new challenges.

7. The system of claim 1 wherein once a challenge has been saved it can be posted to the network in accordance with the procedures established by the system operator.

8. The system of claim 1 wherein the identification prompt comprises user/Seeker identification and/or contact information.

9. The system of claim 1 wherein the background prompt comprises prompts to request background information related to the challenge including one or more of scientific background information, the company's history relating to the challenge and/or other background information.

10. The system of claim 1 wherein the detailed information prompt prompts the user to insert related information regarding the challenge, including one or more of a detailed description, supporting information, solution criteria. Award and/or other detailed information.

11. The system of claim 1 wherein an attachment prompt provides a user to facilitate the ability to attach existing documents or documents created using a separate application that are stored on a hard drive, network drive or otherwise stored but accessible to the user.

12. The system of claim 1 wherein the prompts further including a discipline specification prompt that requests the user to specify one or more disciplines to which the challenge relates and/or specific categories within the disciplines.

13. The system of claim 1 wherein the posted challenge is used as a template for future challenges.
